(19) United States
(12) Patent Application Publication
(10) Pub. No.: US 2024/0250350 A1
(43) Pub. Date: Jul. 25, 2024

(54) PACKAGING MATERIAL FOR ALL-SOLID-STATE BATTERIES AND ALL-SOLID-STATE BATTERY

(71) Applicant: Resonac Packaging Corporation, Hikone-shi (JP)

(72) Inventor: Terutoshi KUMAKI, Hikone-shi (JP)

(73) Assignee: Resonac Packaging Corporation, Hikone-shi (JP)

(21) Appl. No.: 18/437,256

(22) Filed: Feb. 9, 2024

Related U.S. Application Data
(63) Continuation of application No. PCT/JP2022/030549, filed on Aug. 10, 2022.

(30) Foreign Application Priority Data
Aug. 11, 2021 (JP) 2021-131016

(51) Int. Cl. H01M 50/129; H01M 50/105; H01M 50/119; H01M 50/121; H01M 50/133

(52) U.S. Cl. CPC H01M 50/129; H01M 50/105; H01M 50/119; H01M 50/121; H01M 50/133

(57) ABSTRACT

A packaging material for all-solid-state batteries includes a substrate layer, a metal foil layer laminated on an inner surface side of the substrate layer, and a sealant layer laminated on an inner surface side of the metal foil layer. A solid-state battery body is encapsulated by the packaging material. The heat-resistant gas barrier layer is provided between the metal foil layer and the sealant layer. The heat-resistant gas barrier layer is constituted by a resin having hydrogen sulfide gas permeability of 15 {cc·mm/(m²·D·MPa)} or less as measured in accordance with JIS K7126-1.

### CROSS-REFERENCE TO RELATED APPLICATIONS

The present application is a continuation application of International Application No. PCT/JP2022/030549, filed on Aug. 10, 2022, which claims priority to Japanese Patent Application No. 2021-131016, filed on Aug. 11, 2021, the contents of which are incorporated herein by reference in its entirety.

### BACKGROUND OF THE INVENTION

### Technical Field

The present disclosure relates to a packaging material for all-solid-state batteries and an all-solid-state battery. More specifically, it relates to a packaging material for all-solid-state batteries and an all-solid-state battery suitable for use as, but not limited to, a high-power battery for automotive batteries, a battery for portable devices such as mobile electronic devices, a battery for storing regenerative energy, and the like.

### Description of the Related Art

The following description sets forth the inventor's knowledge of related art and problems therein and should not be construed as an admission of knowledge in the prior art.

A lithium-ion secondary battery, commonly used in conventional applications, utilizes a liquid electrolyte as an electrolyte. Therefore, there were risks of separator breakage due to liquid leakage or dendrite generation and, in some cases, ignition due to short-circuit.

In contrast, an all-solid-state battery utilizes a solid-state electrolyte, so it do not cause electrolyte leakage or dendrite generation, and therefore, no separator breakage will occur. Therefore, there is no concern about ignition or the like due to separator breakage, which is attracting a great deal of attention from a safety standpoint.

A regular all-solid-state battery is configured by encapsulating a solid-state battery body, such as an electrode active material and a solid electrolyte, inside a packaging material as a casing. As research on solid-state batteries advances, the performance requirements for packaging materials for all-solid-state batteries have gradually become different from those for conventional batteries using liquid electrolytes. Various packaging materials have been proposed to meet the performance requirements for all-solid-state batteries.

The basic structure of a packaging material for all-solid-state batteries includes a metal foil layer and a heat-fusible layer (sealant layer) laminated inside the metal foil layer, and the sealant layer is heat-sealed to seal a solid-state battery body.

For example, the packaging material for all-solid-state batteries shown in Patent Document 1 has a protective layer interposed between a metal foil layer and a sealant layer, and a hydrogen sulfide gas high in permeability is used as the sealant layer. Further, the packaging material for all-solid-state batteries described in Patent Document 2 uses a layer high in hydrogen sulfide gas permeability as a sealant layer. Further, the packaging material for all-solid-state batteries described in Patent Document 3 utilizes a gas-absorbing sealant layer. Further, the packaging material for all-solid-state batteries described in Patent Document 4 is configured such that a vapor-deposited film layer is laminated on the inner surface of the sealant layer.

### PRIOR ART DOCUMENT

### Patent Document

Patent Document 1: Japanese Patent No. 6777276
Patent Document 2: Japanese Patent No. 6747636
Patent Document 3: Japanese Unexamined Patent Application Publication No. 2020-187855
Patent Document 4: Japanese Unexamined Patent Application Publication No. 2020-187835.

However, the all-solid-state batteries using the packaging materials described in Patent Documents 1 and 2 have a problem that when a hydrogen sulfide gas is generated due to the reaction of the solid electrolyte with moisture in the air, there is a risk that the hydrogen sulfide gas may leak out.

Further, in the packaging materials described in Patent Documents No. 2 to 4, in the case where the sealant layer is fusion bonded (thermally adhered) when encapsulating the battery main body, the resin constituting the sealant layer melts and flows out, causing the sealant layer to become partially thin. This may cause the sealant layer to lose its protective function for the metal foil layer, decreasing insulation properties.

The preferred embodiments of the present disclosure have been made in view of the above-described and/or other problems in the related art. The preferred embodiments of the present disclosure can significantly improve existing methods and/or equipment.

### SUMMARY OF THE INVENTION

The purpose of the present disclosure is to provide a packaging material for all-solid-state batteries and an all-solid-state battery capable of securing sufficient insulating properties even when a sealant layer is thermally bonded and further preventing leakage of a hydrogen sulfide gas, etc., generated inside the battery when the battery main body is encapsulated.

Other objects and advantages of the present disclosure will be apparent from the following preferred embodiments.

In order to solve the above problems, the embodiments of the present disclosure are provided with the following means.

A packaging material for all-solid-state batteries for use in encapsulating a solid-state battery body according to one aspect of the present disclosure includes:
a substrate layer;
a metal foil layer laminated on an inner surface side of the substrate layer;
a sealant layer laminated on an inner surface side of the metal foil layer; and
a heat-resistant gas barrier layer provided between the metal foil layer and the sealant layer,
wherein the heat-resistant gas barrier layer is made of a resin having hydrogen sulfide gas permeability of 15 {cc·mm/(m²·D·MPa)} or less as measured in accordance with JIS K7126-1.

### BRIEF DESCRIPTION OF THE DRAWINGS

Some embodiments of the present disclosure are shown by way of example, and not limitation, in the accompanying figures.

FIG. 1 is a schematic cross-sectional view showing an all-solid-state battery according to an embodiment of the present disclosure.

FIG. 2 is a schematic cross-sectional view showing a packaging material used for all-solid-state batteries according to an embodiment of the present disclosure.

FIG. 3 is a plan view schematically showing an insulation evaluation sample.

FIG. 4 is a cross-sectional view schematically showing an insulation evaluation sample shown in FIG. 3 and a cross-sectional view corresponding to the cross-section taken along the line IV-IV in FIG. 3.

### EMBODIMENTS FOR CARRYING OUT THE INVENTION

In the following paragraphs, some preferred embodiments of the present disclosure will be described by way of example and not limitation. It should be understood based on this disclosure that various other modifications can be made by those skilled in the art based on these illustrated embodiments.

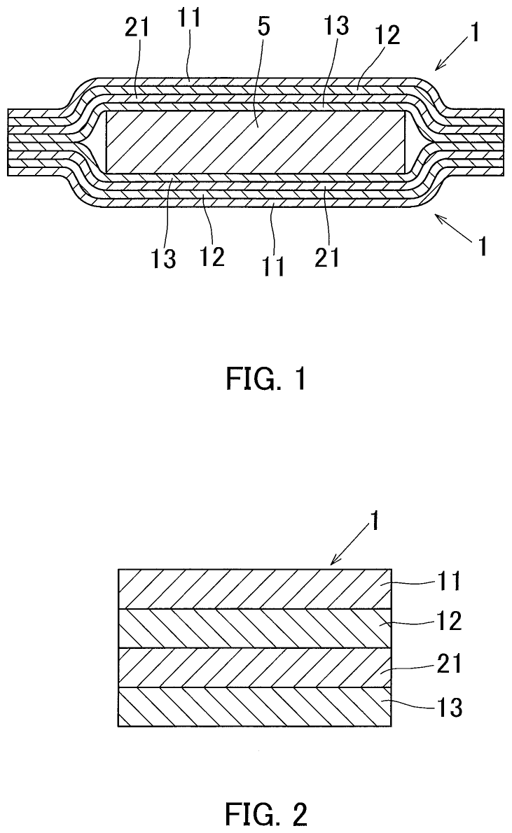

FIG. 1 is a schematic cross-sectional view showing an all-solid-state battery according to an embodiment of the present disclosure. FIG. 2 is a schematic cross-sectional view showing a packaging material used for all-solid-state batteries. As shown in both the figures, the packaging material 1, which is configured as a casing for all-solid-state batteries in this embodiment, is configured by a laminate such as a laminate sheet or the like.

This packaging material 1 is provided with a substrate layer 11 disposed on the outermost side, a metal foil layer 12 laminated on the inner side of the substrate layer 11, a heat-resistant gas barrier layer 21 laminated on the inner side of the metal foil layer 12, and a sealant layer 13 laminated on the inner side of the heat-resistant gas barrier layer 21. In this embodiment, the layers 11 to 13, and 21 of the packaging material 1 are each bonded via an adhesive (adhesive layer) by a dry lamination method. In other words, the packaging material 1 of this embodiment is composed of a laminate consisting of the substrate layer 11/the adhesive layer/the metal foil layer 12/the adhesive layer/the heat-resistant gas barrier layer 21/the adhesive layer/the sealant layer 13.

In this embodiment, as shown in FIG. 1, an all-solid-state battery is produced by encapsulating the solid-state battery body 5 so as to be covered by the packaging material 1 of the above-described configuration. In other words, two rectangular-shaped packaging materials 1 and 1 are stacked one on the other via the solid-state battery body 5, and the sealant layers 13 and 13 of the outer peripheral edge portions of the two (pair of) packaging materials 1 and 1 are jointed together in an airtight (sealed) manner by thermally bonding (heat-sealing), thereby producing a bag-shaped all-solid-state battery in which the solid-state battery body 5 is accommodated within a bag-shaped casing made of the packaging materials 1 and 1.

In the all-solid-state battery of this embodiment, though not shown in the figure, tab leads are provided for electrical extraction. The tab leads are arranged such that one end (inner end) is connected to the solid-state battery body 5, and the middle portion is drawn through the outer peripheral edge portions of the two packaging bodies 1 and 1. The other end portion (outer end portion) is drawn to the outside.

Note that in this embodiment, the casing is formed by bonding two planar packaging materials 1 and 1 together, but not limited thereto. In the present disclosure, at least one of the two exterior materials may be formed into a tray shape in advance, and then the one of the tray-shaped packaging material may be bonded to another tray-shaped or a planar packaging material to form a casing.

Hereinafter, the detailed configuration of the packaging material for the all-solid-state battery 1 of this embodiment will be described.

The substrate layer 11 of the packaging material 1 is constituted by a heat-resistant resin film of 5 μm to 50 μm in thickness. As the resin constituting this substrate layer 11, polyamide, polyester (PET, PBT, PEN), polyolefin (PE, PP), etc., can be suitably used.

The metal foil layer 12 is set to have a thickness of 5 μm to 120 μm and a function to block the ingress of oxygen and moisture from the front surface (outer surface) side. As this metal foil layer 12, an aluminum foil, a SUS foil (stainless steel foil), a copper foil, a nickel foil, etc., can be suitably used. Note that in this embodiment, the terms “aluminum,” “copper,” and “nickel” are used to include their alloys.

By subjecting the metal foil layer 12 to plating, etc., the risk of occurrence of pinholes is reduced, which can improve the function of blocking the ingress of oxygen and moisture even further.

Furthermore, by subjecting the metal foil layer 12 to a chemical conversion treatment, such as, e.g., a chromate treatment, the corrosion resistance further improves. This can more assuredly prevent the occurrence of defects, such as, e.g., chips, and can also improve bonding properties with resin, further enhancing durability.

The sealant layer 13 is set to have a thickness of 10 μm to 100 μm and is composed of a heat-adhesive (heat-fusible) resin film. As the resin constituting this sealant layer 13, a group consisting of polyethylene (LLDPE, LDPE, HDPE), polyolefin such as polypropylene, olefin-based copolymers, their acid-modified products, and ionomers, such as non-stretched polypropylene (CPP, IPP), etc., can be suitably used.

For the sealant layer 13, it is preferable to use a polypropylene based resin (non-stretched polypropylene film (CPP, IPP)), considering the use of tab leads to extract electricity, i.e., sealing and bonding properties with the tab leads.

The heat-resistant gas barrier layer 21 is formed of a resin film that has heat resistance and insulation properties. As the resin constituting this heat-resistant gas barrier layer 21, polyamide (6-nylon, 66-nylon, MXD nylon, etc.), polyethylene terephthalate (PET), polybutylene terephthalate (PBT), polyethylene naphthalate (PEN), cellophane, polyvinylidene chloride (PVDC), etc., are preferably used.

In this embodiment, the resin constituting the heat-resistant gas barrier layer 21 must have specified hydrogen sulfide (H₂S) gas permeability. Specifically, the heat-resistant gas barrier layer 21 must be made of a resin with hydrogen sulfide gas permeability of 15 {cc·mm/(m²·D·MPa)} or less as measured in accordance with JIS K7126-1, preferably 10 {cc·mm/(m²·D·MPa)} or less, more preferably 4.0 {cc·mm/(m²·D·MPa)} or less. In other words, in the case where the hydrogen sulfide gas permeability of the heat-resistant gas barrier layer 21 is set to a value equal to or less than the above-described specified value, the heat-resistant gas barrier layer 21 can prevent a hydrogen sulfide gas from leaking outside when a hydrogen sulfide gas is generated due to a reaction between the solid electrolyte material and moisture in the outside air. In other words, in the case where the hydrogen sulfide gas permeability of the heat-resistant gas barrier layer 21 is excessive, the generated hydrogen sulfide gas may leak out through the packaging material 1 (heat-resistant gas barrier layer 21) to the outside, which is undesirable.

Note that, for reference, the “D” in the hydrogen sulfide gas permeability unit is equivalent to “Day (24 h).

Here, in this embodiment, it is preferable that the sealant layer 13 of the packaging material 1 be composed of a resin layer with hydrogen sulfide gas permeability of 100 {cc·mm/(m²·D·MPa)} or less in accordance with JIS K7126-1. In other words, in the case where the hydrogen sulfide gas permeability of the sealant layer 13 is set to a value equal to or less than the above-described specified value, the hydrogen sulfide gas permeability suppression action of the sealant layer 13 combined with the hydrogen sulfide gas permeability suppression action of the heat-resistant gas barrier layer 21 described above will prevent hydrogen sulfide gas leakage to the outside with even more assuredly.

Further, in this embodiment, as the resin constituting the heat-resistant gas barrier layer 21, it is preferable to set the water vapor transmission rate measured in accordance with JIS K7129-1 (humidity sensor method 40° C. 90% Rh) to a value of 50 (g/m²/day) or less, more preferably 40 (g/m²/day) or less, even more preferably 20 (g/m²/day) or less. That is, the hydrogen sulfide gas is generated when moisture from the outside permeates the packaging material 1 and reacts with the solid electrolyte material. However, when the water vapor transmission rate of the heat-resistant gas barrier layer 21 is set to a value equal to or less than the above-described specified value, the heat-resistant gas barrier layer 21 can prevent moisture penetration. Further, in combination with the gas barrier function of the metal foil layer 12, it is possible to prevent the ingress of moisture more assuredly to prevent a hydrogen sulfide gas itself from being generated. This, in turn, can more assuredly prevent the hydrogen sulfide gas leakage to the outside.

In this embodiment, the thickness (original thickness) of the heat-resistant gas barrier layer 21 is preferably set to 3 μm to 50 μm, more preferably 10 μm to 40 μm. In other words, in the case where the thickness of the heat-resistant gas barrier layer 21 is set within the above-described range, the permeation suppression function of the hydrogen sulfide gas and the water vapor gas described above can be achieved. Even if the sealant layer 13 melts and leaks due to thermal bonding, the heat-resistant gas barrier layer 21 can assuredly ensure the insulating properties. In other words, in the case where the heat-resistant gas barrier layer 21 is excessively thin, there is a risk that its gas permeation suppression function and insulating properties are not secured, which is not desirable. Conversely, in the case where the heat-resistant gas barrier layer 21 is excessively thick, it is not desirable because it not only makes it impossible to make the packaging material 1 thinner but also makes it impossible to fully achieve the effect by making the layer thicker than necessary.

In this embodiment, it is preferable to use a resin film as the heat-resistant gas barrier layer 21. In other words, the entire film becomes a barrier layer, so unlike a vapor-deposited film or the like, no barrier cracks occur, and the barrier property can be improved.

Further, as the resin film constituting the heat-resistant gas barrier layer 21, a non-stretched film or a slightly stretched film can be used, and a non-stretched film is especially preferred. In other words, in the case where a non-stretched film is used, the moldability and the gas barrier property can be further improved.

Further, in this embodiment, in the resin film constituting the heat-resistant gas barrier layer 21, when an original thickness of the resin film is “da0,” and a thickness of the resin film after being pressed under the conditions of 200° C., 0.2 MPa, and 5 seconds is “da1,” it is preferable to configure such that the reduction ratio “da1/da0” is 0.9 or more. In other words, it is preferred to satisfy a relational expression A of “1≥da1/da0≥0.9.” This relational expression A corresponds to the configuration that the reduced rate of the thickness of the heat-resistant gas barrier layer 21 is 10% or less when thermally bonding the packaging materials 1. In this embodiment, in the case where the above relational expression A is satisfied, even if a solid-state battery body 5 is encapsulated by thermally bonding the packaging materials 1 and 1, the decrease in the thickness of the heat-resistant gas barrier layer 21 can be suppressed, and a sufficient thickness can be secured. Consequently, the above-described gas permeation suppression function can be assuredly secured, and the insulation property by the heat-resistant gas barrier layer 21 can also be assuredly secured.

Further, in this embodiment, as the resin constituting the heat-resistant gas barrier layer 21, it is preferable to use a resin whose melting point is higher than that of the resin constituting the sealant layer 13 by 10° C. or more. In other words, when the heat-resistant gas barrier layer 21 has a high melting point, even in the case where the sealant layer 13 is melted when thermally bonding the packaging materials 1 and 1, melting out of the heat-resistant gas barrier layer 21 can be prevented, thereby ensuring assured acquisition of a gas permeation suppression function and insulating properties by the heat-resistant gas barrier layer 21.

Further, in this embodiment, in the resin film constituting the sealant layer 13, when the original thickness of the resin film is “db0,” and the thickness of the resin film after being pressed at 200° C., 0.2 MPa, and 5 seconds is “db1,” it is preferable to configure such that the reduction ratio “db1/db0” is 0.1 or more. In other words, it is preferred to satisfy a relational expression B of “0.5≥db1/db0≥0.1.” This relational expression B corresponds to the configuration that the reduction rate of the thickness of the sealant layer 13 is 50% to 90% when thermally bonding the packaging materials 1. In this embodiment, in the case where the above-described relational expression B is satisfied, the thickness of the sealant layer 13 can be secured to some extent when the solid-state battery body 5 is encapsulated by thermally bonding the packaging materials 1 and 1. Therefore, it is possible to assuredly obtain a sufficient seal performance while securing the insulation properties by the sealant layer 13, by the resin of the sealant layer 13 going around the circumferential gaps of tab leads and foreign substances even if there exist tab leads and/or foreign substances.

On the other hand, in this embodiment, as the adhesive (adhesive layer) for adhering the layers 11 to 13, and 21 of the packaging materials 1 with each other, a two-part curing type adhesive, an energy ray (UV, X-ray, etc.) curing type adhesive, etc., can be used. Among them, a urethane-based adhesive agent, an olefin-based adhesive agent, an acrylic-based adhesive agent, etc., can be suitably used.

According to the all-solid-state battery of this embodiment, as described above, the above-described specific heat-resistant gas barrier layer 21 is interposed between the metal foil layer 12 and the sealant layer 13, and therefore, it is possible to assuredly prevent the generated hydrogen sulfide gas from leaking to the outside. Further, when sealing the solid-state battery body 5, even if the resin of the sealant layer 13 melts and flows out when the sealant layer 13 of the packaging material 1 is subjected to thermal bonding, and the insulating properties of the sealant layer 13 are reduced, the heat-resistant gas barrier layer 21 remains, and therefore, the heat resistance gas barrier layer 21 ensures the insulating properties.

### EXAMPLES

TABLE 1

| | Heat-resistant gas barrier layer | | | | | | | | Sealant |
|---|---|---|---|---|---|---|---|---|---|
| | | Layer | | | Water vapor | | Layer | | layer |
| | | thickness | H₂S gas pemiability | Reduction | transmission | | thickness | H₂S gas pemiability | Reduction |
| | Material | (μm) | cc · mm/(m² · D · Mpa) | ratio | rate (g/m² · D) | Material | (μm) | cc · mm/(m² · D · Mpa) | Radio |
| Ex. 1 | PET | 9 | 5.5 | 0.98 | 29 | CPP | 20 | 45 | 0.4 |
| Ex. 2 | PET | 3 | 10 | 0.99 | 31 | CPP | 30 | 40 | 0.3 |
| Ex. 3 | PET | 15 | 4.5 | 0.98 | 27 | CPP | 20 | 45 | 0.4 |
| Ex. 4 | PET | 25 | 4.2 | 0.99 | 25 | CPP | 20 | 45 | 0.4 |
| Ex. 5 | ONY | 15 | 1.1 | 0.97 | 250 | CPP | 20 | 45 | 0.4 |
| Ex. 6 | ONY | 5 | 1.4 | 0.97 | 300 | CPP | 20 | 45 | 0.4 |
| Ex. 7 | ONY | 40 | 0.9 | 0.99 | 200 | CPP | 20 | 45 | 0.4 |
| Ex. 8 | PET | 9 | 5.5 | 0.98 | 29 | CPP | 60 | 30 | 0.1 |
| Ex. 9 | PET | 9 | 5.5 | 0.98 | 29 | HDPE | 60 | 60 | 0.4 |
| Ex. 10 | PET | 9 | 5.5 | 0.98 | 29 | LLDPE | 60 | 120 | 0.7 |
| Ex. 11 | PET | 9 | 5.5 | 0.98 | 29 | CPP | 10 | 60 | 0.5 |
| Ex. 12 | Cellophane | 20 | 0.1 | 0.99 | 1000 | CPP | 10 | 60 | 0.5 |
| Ex. 13 | PVDC | 10 | 2.9 | 0.98 | 2.0 | CPP | 20 | 45 | 0.4 |
| Ex. 14 | PVDC | 15 | 1.7 | 0.98 | 1.2 | CPP | 30 | 40 | 0.3 |
| Ex. 15 | PVDC | 25 | 1.0 | 0.99 | 0.7 | CPP | 20 | 44 | 0.4 |
| Ex. 16 | PVDC | 2 | 12.9 | 0.99 | 9.0 | CPP | 20 | 45 | 0.4 |
| | (coat) | | | | | | | | |
| Ex. 17 | PVDC | 50 | 0.5 | 0.98 | 0.4 | CPP | 20 | 45 | 0.4 |
| Comp. | — | — | — | — | — | CPP | 20 | 45 | 0.4 |
| Ex. 1 | | | | | | | | | |
| Comp | — | — | — | — | — | CPP | 25 | 40 | 0.3 |
| Ex. 2 | | | | | | | | | |
| Comp | PET | 30 | 25 | 0.99 | 5 | CPP | 20 | 45 | 0.2 |
| Ex. 3 | | | | | | | | | |

### Example 1

### 1. Production of Packaging Material

A chemical conversion treatment solution composed of phosphoric acid, polyacrylic acid (acrylic-based resin), a chromium (111) salt compound, water, and alcohol was applied to both sides of a 40 μm thick aluminum foil (A8021-O) as the metal foil layer 12, and then dried at 180° C. to form a chemical conversion coating. The chromium adhesion amount of this chemical conversion coating was 10 mg/m² per one side.

Next, a 15-μm thick biaxially stretched nylon (ONY-6) film as the substrate layer 11 was dry-laminated (adhered together) to one side (outer surface) of the above-described chemical conversion-treated aluminum foil (metal foil layer 12) via a two-part curing type urethane adhesive agent (3 μm).

Next, as shown in Table 1, as the heat-resistant gas barrier resin layer 21, a 9-μm-thick PET film was bonded to the other side (inner surface) of the aluminum foil after the above-described dry lamination via a two-part curing type urethane-based adhesive agent (3 μm).

Next, as shown in Table 1, a 20 μm-thick CPP film containing a lubricant (e.g., erucamide) as the sealant layer 13 was overlaid on the inner surface of the PET film (heat-resistant gas barrier layer 21) after the above-described dry lamination via a two-component urethane-based adhesive (3 μm), and they were dry-laminated by sandwiching it between a rubber nip roll and a laminating roll heated to 100° C. and crimping to obtain a laminate constituting the packaging material 1.

Next, the laminate was rolled onto a roll shaft and then aged at 40° C. for 10 days to obtain the packaging material sample of Example 1.

### 2. Measurement of H₂S Gas Permeability, Etc., of Resin Film.

The hydrogen sulfide (H₂S) gas permeability of the PET film (heat-resistant gas barrier layer 21) and the CPP film (sealant layer 13) used in preparing the packaging material sample of Example 1 was measured in accordance with JIS K7126-1. The water vapor gas permeability of the PET film was measured in accordance with JIS K7129-1 (humidity sensor method, 40° C., 90% Rh). The results are also shown in Table 1.

### 3. Measurement of Reduction Ratio

The packaging material sample of Example 1 was cut into two pieces each having a width of 15 mm×a length of 150 mm. Thereafter, in a state in which the pair of samples is stacked one on top of the other with the inner sealant layers contacting each other, heat-sealing was performed using a heat-sealing device (TP-701-A) manufactured by Tester Sangyo Co., under the following conditions: heat-sealing temperature: 200° C., sealing pressure: 0.2 MPa (gauge pressure), and sealing time: 2 seconds. Thus, the sample for measuring the reduction ratio of Example 1 was obtained.

In this sample for measuring the reduction ratio, the sealed portion was solidified with a resin, and the cutting portion was cut so that the cross-section appeared. The cross-section was observed by an SEM to determine the thickness of the heat-resistant gas barrier layer 21 and the sealant layer 13, etc.

Then, based on the layer thickness after heat-sealing and the layer thickness of the packaging material sample before heat-sealing, the reduction ratio “da1/da0” of the heat-resistant gas barrier layer 21 and the reduction ratio “db1/db0” of the sealant layer 13 were measured (see the above-described relational expressions A and B). The results are also shown in Table 1.

### 4. Measurement of Seal Strength

TABLE 2

| | | | Vapor transmission |
|---|---|---|---|
| | Seal strength | | rate of packaging |
| | (N/15 mm) | Insulation resistance | material |
| Ex. 1 | 65 | >200 MΩ | ∘ |
| Ex. 2 | 65 | >200 MΩ | ∘ |
| Ex. 3 | 65 | >200 MΩ | ∘ |
| Ex. 4 | 65 | >200 MΩ | ∘ |
| Ex. 5 | 65 | >200 MΩ | ∘ |
| Ex. 6 | 65 | >200 MΩ | ∘ |
| Ex. 7 | 65 | >200 MΩ | ∘ |
| Ex. 8 | 65 | >200 MΩ | ∘ |
| Ex. 9 | 45 | >200 MΩ | ∘ |
| Ex. 10 | 25 | >200 MΩ | ∘ |
| Ex. 11 | 65 | >200 MΩ | ∘ |
| Ex. 12 | 65 | >200 MΩ | ∘ |
| Ex. 13 | 65 | >200 MΩ | ∘ |
| Ex. 14 | 65 | >200 MΩ | ∘ |
| Ex. 15 | 65 | >200 MΩ | ∘ |
| Ex. 16 | 65 | 130 MΩ | ∘ |
| Ex. 17 | 30 | >200 MΩ | ∘ |
| Comp. Ex. 1 | 65 | 7 MΩ | x |
| Comp. Ex. 2 | 65 | 100 MΩ | x |
| Comp. Ex. 3 | 65 | >200 MΩ | x |

The packaging material sample of Example 1 was cut into two pieces each having a width of 15 mm×a length of 150 mm. Thereafter, in a state in which the pair of samples was stacked one on top of the other with the inner sealant layers contacting each other, heat-sealing was performed using a heat-sealing device (TP-701-A) manufactured by Tester Sangyo Co., under the following conditions: heat-sealing temperature: 200° C., sealing pressure: 0.2 MPa (gauge pressure), and sealing time: 2 seconds. Thus, a sample for evaluating the seal strength of Example 1 was obtained.

For the sample for evaluating the seal strength, a Strograph (AGS-5kNX) manufactured by Shimadzu Access Co., Ltd. was used in accordance with JIS Z0238-1998 to measure the peel strength when the seal strength evaluation sample was T-peeled at a tensile speed of 100 mm/min between the inner sealant layers of the sealed portion. This was used as the seal strength (N/15 mm width). The results are shown in Table 2.

### 5. Measurement of Insulation Resistance (Evaluation of Insulation Properties)

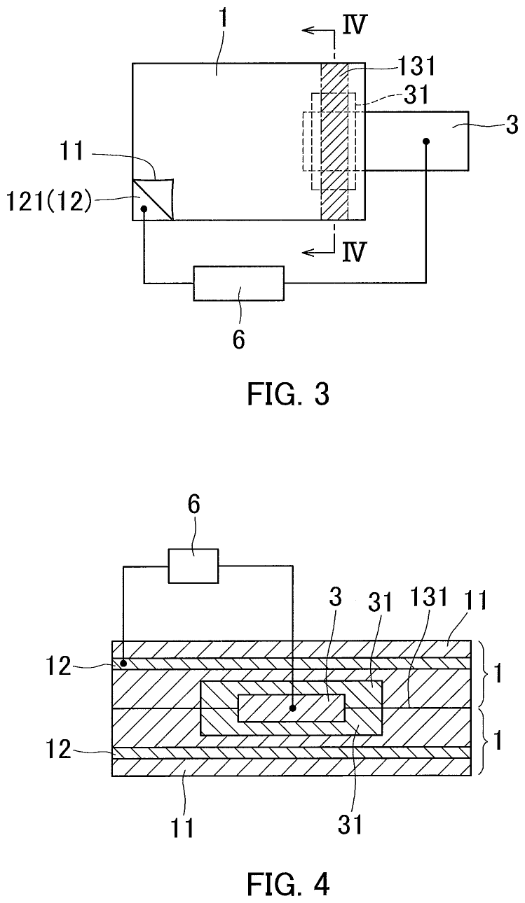

As shown in FIG. 3 and FIG. 4, the packaging material sample 1 of Example 1 was cut into two pieces each having a length of 100 mm and a width of 50 mm. The pair of packaging material samples 1 and 1 was stacked one on top of the other with the sealant layer 13 facing each other and in contact with each other. On the other hand, a tab lead 3 made of an aluminum foil with a width of 10 mm and a thickness of 100 μm was placed between the above-described pair of packaging material samples 1 and 1, while placing a tab film 31 made of an acid modified polypropylene film with a thickness of 50 μm on both sides of the tab lead. At this time, the part of the tab lead 3 was placed between the pair of packaging material samples 1 and 1, and the rest of the tab lead 3 was positioned so as to be pulled outward from the edges of the pair of packaging material samples 1 and 1. The unbonded samples were heat-fused between the sealant layers for 2 seconds using a double-sided heat sealer heated from both the top and bottom sides of its packaging material samples 1 and 1 under the conditions of a seal width of 5 mm, 200° C., and 0.2 MPa, to obtain a sample for evaluating insulating properties.

Note that in the plan view of the sample for evaluating insulation properties in FIG. 3, the thermally bonded portion (heat-sealed portion) 131 is hatched with a diagonal line to facilitate understanding of the invention. Further, in the cross-sectional view of the insulation property evaluation sample in FIG. 4, the heat-resistant gas barrier layer 13 is not illustrated to make the structure easier to understand.

Then, as shown in FIG. 3, at the end portion of the insulating property evaluation sample in the length direction thereof, the resin as the substrate layer 11 was partially peeled off to partially expose the aluminum foil as the metal foil layer 12, and at the exposed portion 121, conductivity from outside with the aluminum foil (metal foil layer 12) was secured.

Then, one of the terminals of the insulation resistance measurement device (made by Hioki Electric Co., Ltd.: product number “HIOKI 3154”) 6 was connected to the metal foil layer 12 on the exposed portion 121 of the insulation evaluation sample described above, and the other terminal was brought into contact with the tab lead 3 to form a circuit. After forming the circuit, a voltage was applied between the metallic foil layer 12 and the tab lead 3 in the circuit for 5 seconds at 25 V, and the resistance was measured to determine the insulation resistance value. The results are also shown in Table 2.

### 6. H₂S Gas Permeation Evaluation of Exterior Material

Using a copper foil (Cu foil) of 9 μm thickness instead of an aluminum foil, in the same manner as described above, a copper foil type packaging material sample 1 of Example 1 was prepared.

This copper foil type packaging material sample was cut into two pieces of 30 mm×50 mm in size. The pair of samples 1 and 1 were stacked one on top of the other with the sealant layer 13 facing each other. The three sides (“three sides”) of the stacked packaging material samples 1 and 1 were heat-sealed at 200° C., under the seal pressure of 0.2 MPa (gauge pressure) for the seal time of 2 seconds to produce a three-sided bag. Thereafter, at one side (30 mm side) of the opening of the three-way bag, a needle is inserted between the packaging material samples 1 and 1, and the opening is sealed under the same sealing conditions as described above, and the H₂S gas was filled through the needle at 0.1 MPa (the needle was inserted at a side of 30 mm).

Once the gas was sealed, the syringe needle was pulled out slightly to prevent the gas from leaking out, and the inside from the tip of the needle was heat-sealed again under the same sealing conditions to completely seal the gas. Then, the syringe needle was pulled out to produce the gas-filled bag.

The gas-filled bags were placed in a thermostatic chamber at 40° C. for 7 days, then degassed, and the seals were peeled off for internal observation. By the observation, those in which no change was observed in the Cu foil were evaluated as “◯,” and those in which discoloration was observed in the sealing area, etc., were evaluated as “X.” The results are also shown in Table 2.

### Example 2

A sample of Example 2 was prepared in the same manner as in Example 1, except that a PET film of 3 μm thickness was used as the heat-resistant gas barrier layer 21 and a CPP film of 30 μm thickness was used as the sealant layer 13. Then, measurements (evaluations) were performed in the same manner as in Example 1. The results are also shown in Table 1 and Table 2.

### Example 3

A sample of Example 3 was prepared in the same manner, except that a PET film of 15 μm thickness was used as the heat-resistant gas barrier layer 21. Then, measurements (evaluations) were performed in the same manner as in Example 1. The results are also shown in Table 1 and Table 2.

### Example 4

A sample of Example 4 was prepared in the same manner as in Example 1, except that a PET film of 25 μm thickness was used as the heat-resistant gas barrier layer 21, and then measurements (evaluations) were performed in the same manner as in Example 1. The results are also shown in Table 1 and Table 2.

### Example 5

A sample of Example 5 was prepared in the same manner as in Example 1, except that a film of 15 μm thickness was used as the heat-resistant gas barrier layer 21, and then measurements (evaluations) were performed in the same manner as in Example 1. The results are also shown in Table 1 and Table 2.

### Example 6

A sample of Example 6 was prepared in the same manner as in Example 1, except that a film of 5 μm thickness was used as the heat-resistant gas barrier layer 21, and then measurements (evaluations) were performed in the same manner as in Example 1. The results are also shown in Table 1 and Table 2.

### Example 7

A sample of Example 7 was prepared in the same manner as in Example 1, except that a film of 40 μm thickness was used as the heat-resistant gas barrier layer 21, and then measurements (evaluations) were performed in the same manner as in Example 1. The results are also shown in Table 1 and Table 2.

### Example 8

A sample of Example 8 was prepared in the same manner as in Example 1, except that a CPP film of 60 μm thickness was used as the sealant layer 13, and then measurements (evaluations) were performed in the same manner as in Example 1. The results are also shown in Table 1 and Table 2.

### Example 9

A sample of Example 9 was prepared in the same manner as in Example 1, except that an HDPE film of 60 μm thickness was used as the sealant layer 13, and then measurements (evaluations) were performed in the same manner as in Example 1. The results are also shown in Table 1 and Table 2.

### Example 10

A sample of Example 10 was prepared in the same manner as in Example 1, except that an LLDPE film of 60 μm thickness was used as the sealant layer 13, and then measurements (evaluations) were performed in the same manner as in Example 1. The results are also shown in Table 1 and Table 2.

### Example 11

A sample of Example 11 was prepared in the same manner as in Example 1, except that a CPP film of 10 μm thickness was used as the sealant layer 13, and then measurements (evaluations) were performed in the same manner as in Example 1. The results are also shown in Table 1 and Table 2.

### Example 12

A sample of Example 12 was prepared in the same manner as in Example 1, except that a cellophane film film of 20 μm thickness was used as the heat-resistant gas barrier layer 21 and a CPP film of 10 μm thickness was used as the sealant layer 13. Then, measurements (evaluations) were performed in the same manner as in Example 1. The results are also shown in Table 1 and Table 2.

### Example 13

A sample of Example 13 was prepared in the same manner as in Example 1, except that a polyvinylidene chloride (PVDC) film of 10 μm thickness was used as the heat-resistant gas barrier layer 21, and then measurements (evaluations) were performed in the same manner as in Example 1. The results are also shown in Table 1 and Table 2.

### Example 14

A sample of Example 14 was prepared in the same manner as in Example 1, except that a PVDC film of 15 μm thickness was used as the heat-resistant gas barrier layer 21, and a CPP film of 30 μm thickness was used as the sealant layer 13. Then, measurements (evaluations) were performed in the same manner as in Example 1. The results are also shown in Table 1 and Table 2.

### Example 15

A sample of Example 15 was prepared in the same manner as in Example 1, except that a PVDC film of 25 μm thickness was used as the heat-resistant gas barrier layer 21, and then measurements (evaluations) were performed in the same manner as in Example 1. The results are also shown in Table 1 and Table 2.

### Example 16

A sample of Example 16 was prepared in the same manner as in Example 1, except that a heat-resistant gas barrier layer 21 was formed by coating the PVDC with a thickness of 2 μm on the other side (inner side) of an aluminum foil for a metal foil layer, and then measurements (evaluations) were performed in the same manner as in Example 1. The results are also shown in Table 1 and Table 2.

### Example 17

A sample of Example 17 was prepared in the same manner as in Example 1, except that a PVDC film of 50 μm thickness was used as the heat-resistant gas barrier layer 21, and then measurements (evaluations) were performed in the same manner as in Example 1. The results are also shown in Table 1 and Table 2.

### Comparative Example 1

Samples were prepared in the same manner as in Example 1, except that the heat-resistant gas barrier layer 21 was not formed, and the same measurements (evaluations) were performed. The results are also shown in Table 1 and Table 2.

### Comparative Example 2

A sample of Comparative Example 2 was prepared in the same manner as in Example 1 except that a CPP film of 25 μm thickness was used as the sealant layer 13 without forming the heat-resistant gas barrier layer 21, and then measurements (evaluations) were performed in the same manner as in Example 1. The results are also shown in Table 1 and Table 2.

### Comparative Example 3

A sample of Comparative Example 3 was prepared in the same manner as in Example 1, except that an OPP film of 30 μm thickness was used as the heat-resistant gas barrier layer 21, and then measurements (evaluations) were performed in the same manner as in Example 1. The results are also shown in Table 1 and Table 2.

### <Overall Review>

As will be clear from Table 2, for the packaging material samples of Examples 1 to 17, which are related to the present disclosure, excellent results were obtained in all evaluations of insulation properties and gas permeability. However, the packaging material sample of Example 16 having a thin heat-resistant gas barrier layer 21 was slightly inferior in insulation properties, and the packaging material sample of Example 17 having a thicker heat-resistant gas barrier layer was slightly lower in sealing intensity.

In contrast, the packaging material samples of Comparative Examples 1 to 3, which are out of the gist of the present disclosure, could not obtain good results in the evaluation of gas permeability, and some of them could not obtain good results in the evaluation of insulating properties.

### [Aspects]

It would be understood by those skilled in the art that the exemplary embodiments described above are specific examples of the following aspects.

[1] A packaging material for all-solid-state batteries for use in encapsulating a solid-state battery body, comprising:
a substrate layer;
a metal foil layer laminated on an inner surface side of the substrate layer;
a sealant layer laminated on an inner surface side of the metal foil layer; and
a heat-resistant gas barrier layer provided between the metal foil layer and the sealant layer,
wherein the heat-resistant gas barrier layer is made of a resin having hydrogen sulfide gas permeability of 15 {cc·mm/(m²·D·MPa)} or less as measured in accordance with JIS K7126-1.

[2] The packaging material for all-solid-state batteries, as recited in the above-described Item 1,
wherein the resin constituting the heat-resistant gas barrier layer is formulated to satisfy a relational expression of:

$$1 ≧ da 1 / da 0 ≧ 0.9$$

where “da0” is an original thickness of the resin, and “da1” is a thickness of the resin when pressed under conditions of 200° C., 0.2 MPa, and 5 seconds.

[3] The battery packaging material as recited in the above-described Item 1 or 2,
wherein the heat-resistant gas barrier layer is set to 3 μm to 50 μm in thickness.

[4] The packaging material for all-solid-state batteries as recited in any one of the above-described Items 1 to 3,
wherein the sealant layer is constituted by a resin layer with hydrogen sulfide gas permeability of 100 {cc·mm/(m²·D·MPa)} or less.

[5] The packaging material for all-solid-state batteries as recited in any one of the above-described Items 1 to 4,
wherein the resin constituting the sealant layer is formulated to satisfy a relational expression of:

$$0 \text{.5} ≧ db 1 / db 0 ≧ 0.1$$

where “db0” is an original thickness of the resin, and “db1” is a thickness of the resin when pressed under conditions of 200° C., 0.2 MPa, and 5 seconds.

[6] The packaging material for all-solid-state batteries as recited in any one of the above-described Items 1 to 5,
wherein the resin constituting the heat-resistant gas barrier layer has a water vapor transmission rate of 50 (g/m²/day) or less as measured in accordance with JIS K7129-1 (humidity sensor method 40° C. 90% Rh).

[7] An all-solid-state battery comprising:
the packaging material for all-solid-state batteries, as recited in any one of the above-described Items 1 to 6; and
a solid-state battery body encapsulated by the packaging material.

In the embodiment of the present disclosure, according to the packaging material for all-solid-state batteries as recited in the above-described Item [1], the heat-resistant gas barrier layer is interposed between the metal foil layer and the sealant layer, and therefore, the generated hydrogen sulfide gas is assuredly prevented from leaking to the outside. Further, in encapsulating a solid-state battery body using this packaging material, even if the sealant layer's insulating properties are reduced due to the melting and leaking of resin from the sealant layer when the sealant layer is thermally bonded, the heat-resistant gas barrier layer remains. Therefore, the heat resistance properties can be assuredly secured by the heat barrier layer.

According to the embodiment of the present disclosure of the packaging material for all-solid-state batteries as recited in the above-described Items [2] or [3], when the solid-state battery body is sealed by thermal bonding, the thickness of the heat-resistant gas barrier layer can be sufficiently secured. Therefore, it is possible to assuredly prevent the leakage of the hydrogen sulfide gas and also possible to assuredly secure good insulating properties.

According to the packaging material for all-solid-state batteries recited in the above-described Item [4] according the embodiment of the present disclosure, the sealant layer can also prevent the gas leakage of a hydrogen sulfide gas. Therefore, it is possible to prevent the leakage of the hydrogen sulfide gas more assuredly.

According to the packaging material for all-solid-state batteries as recited in the above-described Item [5] according to the embodiment of the present disclosure, when the solid-state battery body is sealed by thermal bonding, the thickness of the sealant layer can be secured to some extent. Therefore, the insulating properties and the sealing performance can be further improved.

According to the packaging material for all-solid-state batteries as recited in the above-described Item [6] according to the embodiment of the present disclosure, the ingress of moisture can be prevented, and the generation of the hydrogen sulfide gas itself can be suppressed. Therefore, it is possible to more assuredly prevent the leakage of the hydrogen sulfide gas.

In the above-described Item [7] according to the embodiment of the present disclosure, it identifies an all-solid-state battery using the packaging material as recited in any one of the above-described Items [1] to [6], and therefore, the same effects as described above can be obtained.

It should be recognized that the terms and expressions used herein are for illustrative purposes only, are not to be construed as limiting, do not exclude any equivalents of the features shown and described herein, and allow for various variations within the claimed scope of this invention. It should be recognized that the invention does not exclude any equivalents of the features shown and described herein, but permits various variations within the claimed scope.

### INDUSTRIAL APPLICABILITY

The packaging material for all-solid-state batteries according to the above-described disclosure can be suitably used as a material for a casing to accommodate a solid-state battery main body.

### DESCRIPTION OF REFERENCE SYMBOLS

1: Packaging material
11: Substrate layer
12: Metal foil layer
13: Sealant layer
21: Heat-resistant gas barrier layer
5: Solid-state battery body

1. A packaging material for all-solid-state batteries for use in encapsulating a solid-state battery body, comprising:
a substrate layer;
a metal foil layer laminated on an inner surface side of the substrate layer;
a sealant layer laminated on an inner surface side of the metal foil layer; and
a heat-resistant gas barrier layer provided between the metal foil layer and the sealant layer,
wherein the heat-resistant gas barrier layer is made of a resin having hydrogen sulfide gas permeability of 15 {cc·mm/(m²·D·MPa)} or less as measured in accordance with JIS K7126-1.

2. The packaging material for all-solid-state batteries, as recited in claim 1,
wherein the resin constituting the heat-resistant gas barrier layer is formulated to satisfy a relational expression of:
$$1 ≧ da 1 / da 0 ≧ 0.9$$
where “da0” is an original thickness of the resin, and “da1” is a thickness of the resin when pressed under conditions of 200° C., 0.2 MPa, and 5 seconds.

3. The packaging material for all-solid-state batteries, as recited in claim 1,
wherein the heat-resistant gas barrier layer is set to 3 μm to 50 μm in thickness.

4. The packaging material for all-solid-state batteries, as recited in claim 1,
wherein the sealant layer is made of a resin with hydrogen sulfide gas permeability of 100 {cc·mm/(m²·D·MPa)} or less.

5. The packaging material for all-solid-state batteries, as recited in claim 1,
wherein the resin constituting the sealant layer is formulated to satisfy a relational expression of:
$$0.5 ≧ db 1 / db 0 ≧ 0.1$$
where “db0” is an original thickness of the resin, and “db1” is a thickness of the resin when pressed under conditions of 200° C., 0.2 MPa, and 5 seconds.

6. The packaging material for all-solid-state batteries, as recited in claim 1,
wherein the resin constituting the heat-resistant gas barrier layer has a water vapor transmission rate of 50 (g/m²/day) or less as measured in accordance with JIS K7129-1 (humidity sensor method 40° C. 90% Rh).

7. An all-solid-state battery comprising:
the packaging material for all-solid-state batteries, as recited in claim 1; and
a solid-state battery body encapsulated by the packaging material.
